(19) United States
(12) Patent Application Publication
(10) Pub. No.: US 2015/0315055 A1
(43) Pub. Date: Nov. 5, 2015

(54) Water Treatment Process

(71) Applicant: Aquatech International Corporation, Canonsburg, PA (US)

(72) Inventors: Ravi Chidambaran, Canonsburg, PA (US); Narendra Singh Bisht, Pune (IN); Pavan Raina, Pune (IN)

(21) Appl. No.: 14/650,422

(22) PCT Filed: Nov. 21, 2013
(86) PCT No.: PCT/US2013/071236

§ 371 Date: Jun. 8, 2015

Related U.S. Application Data
(60) Provisional application No. 61/734,606, filed on Dec. 7, 2012.

(30) Foreign Application Priority Data
Sep. 27, 2013 (IN) 2873/DEL/2013

(51) Int. Cl. C02F 9/00; E21B 43/40; E21B 43/24

(52) U.S. Cl. CPC C02F 9/00; E21B 43/24; E21B 43/40; C02F 1/463

(57) ABSTRACT

A process for enhanced removal of impurities from water by an enhanced multi-step electrocoagulation process including electrocoagulation, solids separation, hardness removal, crystallization, and, optionally, reverse osmosis and evaporative purification. Embodiments of the invention may remove multiple impurities at substantial savings in time, energy, and chemical use. Zero liquid discharge options are also reported.

### CROSS-REFERENCE TO RELATED APPLICATIONS

This application is the national phase under 35 U.S.C. §371 of PCT International Application No. PCT/US2013/071236, filed on Nov. 21, 2013, which claims priority to U.S. Provisional Patent Application No. 61/734,606, filed on Dec. 7, 2012, and to Indian Patent Application No. 2873/DEL/2013, filed on Sep. 27, 2013, and which are both incorporated by reference herein.

### BACKGROUND OF THE INVENTION

1. Field of the Invention

Embodiments of the invention related to methods and apparatuses for treatment of water. Preferred embodiments use electrocoagulation in combination with one or more other treatment options.

2. Background of the Related Art

“Produced water” is water that is used in the production of oil, gas, or other hydrocarbons. Treatment of produced water for removal of impurities typically involves a variety of pretreatment processes. This impurity removal is typically conducted to enable recycling and production of steam through boilers. In conventional treatment methods, produced water is introduced to evaporators at high pH and including significant amounts of dissolved and precipitated impurities, including but not limited to silica, hardness, boron, alkalinity, organics, and color. If left untreated these impurities create scaling, foaming, precipitation and other undesirable effects when the water is concentrated in the evaporator and distillate is recovered. Brine generated by conventional evaporation processes is difficult to dispose of. This is due to creation of a gelatinous colloidal silica mixture during neutralization. Using conventional technology this brine cannot be converted into solids in a zero liquid discharge process through crystallizers, because the presence of a large quantity of organics makes it tarry and difficult to handle.

Depending on factors including the original source of the produced water, the method of extraction used for the hydrocarbons, and the location of the hydrocarbon removal, produced water may contain different contaminants. Typically silica, hardness, oil, and color organics are considered major contaminants in produced water. For example, produced water used in the oil sands extraction process commonly known as Steam Assisted Gravity Drainage, or “SAGD,” is water that has been used for oil extraction by injecting a steam into an area having oil sands. The SAGD process includes recovery of both the steam and the oil stream. After initial oil separation the water is typically treated. Major contaminants that are present creating scaling, precipitation or brine handling problems include boron, silica, hardness, oil and color-contributing naturally occurring ingredients and organics.

Typically conventional processes for water purification are designed around treatments that include control of one or more contaminants to contain scaling or precipitation. These processes do not completely address the removal, conditioning and handling of all the contaminants to make the process robust in terms of reliability of operation and reduction of loss of productivity due to down time. Conventional processes also require expensive chemicals for operations and frequent cleaning to overcome scaling problems. None of the existing conventional processes address the removal of silica, hardness and scaling ions like boron and strontium, or color contributing compounds and total organic carbon (TOCs) in totality. This causes the need for subsequent processing and consumption of significant amounts of chemicals. Conventional processes also require facilities for chemicals handling and storage. Some processes further require solid storage, handling and unloading systems.

Produced water, and especially oil sands produced water, is difficult to treat through a reverse osmosis (“RO”) process for a number of reasons. These include, for example, of the level of difficulty experienced in making the pre-treatment process work, which in turn is due to the presence of a number of contaminants and complexity of different treatments required. Even after a number of pretreatments and use of different chemicals it has not been possible to treat silica, hardness, oil and organics to the right levels, while still getting turbidity and SDI in the right range for treatability through RO. Therefore an RO process is not considered viable for produced water and especially oil sands produced water.

### BRIEF SUMMARY OF THE INVENTION

We propose a comprehensive water treatment solution that includes treatment of contaminants including but not limited to silica, hardness, boron, phosphates, alkalinity, color, colloids, oil, and organics. Treatment depends on the subsequent concentration and permeate or distillate recovery process and quality requirements. This solution may further address brine handling and neutralization problems and should further allow achievement of zero liquid discharge (ZLD) to have minimum environmental impact.

Our solution may include a membrane process, which may result in beneficial lower capital costs. If this option is available 90% of water can be recovered at lower costs and evaporators need to be employed for 10% of water especially if a ZLD approach is required.

Further embodiments may provide consecutive electrocoagulation steps. For example, 2, 3, 4, or more electrocoagulation steps may be conducted for successive removal of impurities.

### BRIEF DESCRIPTION OF THE DRAWINGS

FIG. 1 shows a flow chart of one embodiment of the invention wherein the produced water is first treated through a multi-contaminant removal electrocoagulation (EC) process, then passes through a solid separator followed by removal of hardness through a hardness removal units (HRU) and evaporators. In the evaporators distillate is recovered and brine is either disposed of or sent to a crystallizer for further salt recovery. A solid separator may be, for example, but is not limited to, a clarifier, filter press, belt press, or a centrifuge.

FIG. 2 shows an embodiment of the invention wherein the produced water is treated through a multi-contaminant removal electro coagulation (EC) process and then further treated through hardness removal units and ultrafiltration or microfiltration system (“UF/MF”) and further processed through a reverse osmosis (“RO”) membrane based system. Further distillate can be recovered by passing RO reject water through an evaporator/crystallizer. This provides a ZLD solution.

FIG. 3 shows an embodiment of the invention wherein the produced water is treated through a multi-contaminant removal electro coagulation (EC) process followed by solid separator and hardness removal unit (HRU).

FIG. 4 shows an embodiment of the invention wherein a membrane distillation (MD) system is used for the concentration of RO unit brine water after the treatment of produced water through multi-contaminant removal EC, HRU and UF/MF system. The brine generated by MD is optionally further passed through a crystallizer to make the process a ZLD process.

FIG. 5 shows an embodiment of the invention that includes multi-contaminant removal EC, HRU, and UF/MF, and a double pass RO system. The double pass RO permeate is optionally further treated through demineralizers or electro-deionization to make ultra pure water.

FIG. 6 shows a high temperature multi-contaminant removal enhanced EC process that is available as a single or multi-pass process followed by filters to deliver efficient silica and hardness removal, in addition to removal of other contaminants, as a substitute for warm/hot lime softening for feed water. As in other examples, this feed water may be produced water.

FIG. 7 shows a flow diagram for water subjected to multi-step electrocoagulation at different conditions. This multi-step electrocoagulation process may be used to substitute for any single-step electrocoagulation process shown in the preceding figures.

FIG. 8, including two parts FIG. 8A and FIG. 8B, shows a flow diagram of an embodiment for treating water for heavy oil production, including separating an oil and water mixture obtained from a first injection well into separate mixtures of oil and produced water; sending the produced water to a header of an electrocoagulation system as electrocoagulation feedwater; (c) treating the produced water by electrocoagulation at a first set of conditions; (d) treating the produced water by electrocoagulation at a second set of conditions, wherein the second set of conditions varies from the first set of conditions; (e) removing solids from the produced water after the steps of treating the produced water by electrocoagulation; (f) removing hardness from the produced water; (g) treating the produced water by at least one process selected from the group consisting of reverse osmosis, crystallization, evaporation, and membrane filtration; (h) generating steam with the produced water; and (i) sending the steam to a second injection well, wherein said injection well may be the same or different as the first injection well.

### DETAILED DESCRIPTION OF THE INVENTION

Embodiments of the invention relate to an integrated process for a comprehensive treatment of a plurality of contaminants in water. In preferred embodiments the water is produced water from hydrocarbon extraction. Preferred embodiments may, but are not required to, overcome one or more of the shortcomings described above and allows a zero liquid discharge (“ZLD”) solution. This ZLD solution may be offered without any brine handling issues. The integrated water treatment process involves an enhanced multi contamination co-precipitation EC process followed by HRU for evaporative processes. Although embodiments are described herein as directed to produced water, the methods reported herein may find useful application in a variety of processes and situations, including but not limited to when the stream of water is an input to or a product of a water selected from the group consisting of off-shore oil recovery water, off-shore gas recovery water, oil polymer flood water, water subjected to warm lime softening, coal to chemicals (“CTX”) process water, coal seam gas (“CSG”) waters, coal bed methane waters, flue gas desulfurization water, on-shore oil recovery water, on-shore gas recovery water, hydraulic fracturing water, shale gas extraction water, water including substantial biological content, power plant water, low-salinity oil recovery water, off-shore low-salinity produced water, and cooling tower blowdown water.

In one embodiment of the invention we provide a system and method for purification of water used for hydraulic fracturing, or “fracking.” “Fracking” traditionally uses substantial quantities of water, and this water may include, for example, large amounts of biological components and/or silica. Use of a multiple-step electrocoagulation process can effectively remove these and other contaminants, allowing beneficial reuse of the water for further fracking or other operations.

Although embodiments of the invention have been described herein in the context of methods, those of skill in the art will understand that both systems and apparatus are also contemplated. Systems and apparatus of the invention will have the components necessary to practice the method steps that are reported herein. Evaporators may be, for example, but are not limited to natural or forced-circulation evaporators, falling film evaporators, rising film evaporators, plate evaporators, or multiple-effect evaporators. Membranes may use polymeric, ceramic, or other membranes. In one embodiment an electrocoagulation system, including a multi-stage electrocoagulation system, may be added to an existing water purification plant either before or after a warm lime softener and in conjunction with the addition of a blowdown evaporator.

Embodiments of the invention may offer enhanced EC followed by HRU and UF/MF processing for use in a reverse osmosis purification. As an alternative to, or in addition to reverse osmosis, processes such as nano-filtration, evaporation, crystallization, or combinations thereof may be used. This is further followed by an evaporator/crystallizer to achieve ZLD for brines generated by evaporator or reverse osmosis plant reject. This process also involves optional utilization of brine or salt for regeneration of HRU.

The multi-contaminant removal enhanced EC process involves application of a mild DC current. Electro coagulation involves reactions like de-emulsification of oil and grease, oxidation, reduction and coagulation. A DC voltage is applied to generate a wide range of current densities in single or multiple stages. In single stage EC, higher current densities need to be applied to remove all the contaminants together, but in multiple stages different current densities can be applied based on type of contaminants to be removed. The multiple stage EC typically uses much less power in terms of overall power consumption as compared to a single stage EC process.

Application of voltage to generate a current density from 20-80 amp/m², preferably between 15-60 amp/m² depending on flow rate and TDS of water at different voltages and residence time of 1-30 minutes removes a majority of many typical impurities. In a particular embodiment the residence time is greater than 10 minutes. Typical impurities that are removed include, for example, but are not limited to boron (removed at 50-80%), silica (removed at >90%), hardness (including calcium and magnesium) (removed at 70-90%), bi-carbonate alkalinity (removed at 50-70%), color (removed at 90-95%), organics and oil (removed at 70-90%) strontium (removed at >50%), and phosphate (removed at >50%) in a single stage.

The same result can be achieved by using, for example, a current density of 15-30 amp/m² in first stage for a residence time of 5-30 minutes followed by higher current density of 20-60 amp/m2 for 1-5 minutes without any side reactions. The current density can be increased to reduce residence time by application of higher voltages; however, excessive currents may create side reactions and scaling when handling complex waters and make the process unsustainable. To drive removal of multiple contaminants, the process can controlled by increasing the current through a single stage or alternatively have multiple stages to accomplish maximum removal and prevent side reactions. These side reactions include, for example, charring, deposition of organics, scaling of cathode, and excessive loss of anode material. Side reactions are especially where multiple contaminants of different kinds are present.

The multiple stages involve more than one stage. For example, the number of stages may be two, three, four, five, or more. The multistage multiple contaminant removal process involves separation of one set of contaminants at one set of current density and other contaminants in subsequent stages under different conditions of current densities. For example, removal of organics can be performed in an early stage requiring lower current density. This reduces the volume and type of foam produced in the process and, therefore, also reduces loss of water with the foam.

As noted above, application of higher current densities in one single stage for removal of multiple contaminants by EC creates side reactions and results in a loss of efficiency. This manifests in, for example, excessive foaming, charring of organics and create a coating on the cathodes, which would further increase the resistance and demand more power progressively.

A multistage process is able to separate organic and inorganic sludge. It also makes those sludges easily filterable because organic sludge may not easily filter out, and if it mixes in the bulk sludge, it will make overall sludge filtration properties sluggish. A multistage process also helps in fractionation and separation of contamination and subsequent recycling of the separated products for beneficial use. This approach optimizes power consumption and reduces unnecessary side reactions.

Embodiments of the invention may use a variety of electrode materials. Common sacrificial anodes materials include but are not limited to iron, aluminum, zinc, and others. Cathode materials include, for example, but are not limited to, stainless steel and non-active alloy materials like titanium, platinum, and tungsten. Other electrode materials are discussed below. The option of using different electrode materials in different stages can be exercised depending on the level of contaminants one is trying to remove. The spacing between the electrodes can be varied depending on the water characteristics. Typically it varies from 2-6 mm. The electrode spacing in different staging can be different; for example, one can have higher electrode spacing in the first stage and lower spacing in a subsequent stages or the other way around. If there are more than two stages the electrode spacing may be different in different stages. Agitation and mixing to control scaling and coating of electrodes and to cause better contact with electrode material should also be considered. These can be controlled in different stages by incorporating different rates of agitation or recirculating flows.

The type of materials used for anodes in embodiments of the invention may be sacrificial anodes or non-sacrificial anodes. Non-sacrificial anodes may be, for example, graphite or non-active metals and their alloys. Suitable non-active metals include, for example, titanium, platinum, and tantalum. When these non-sacrificial anodes are used, the process may also include dosing of coagulants of metals that, when taken alone, are useful as sacrificial electrodes. These include, for example, iron and aluminum in the form of their salts. These may be, for example, but are not limited to ferric chloride, ferrous sulfate, aluminum chloride, aluminum sulfate, alum, or others. When non-sacrificial anodes are used, the electrode will not need frequent, regular replacement. To arrive at a balance of optimum chemical consumption and electrode replacement, one can use a combination of sacrificial and non-sacrificial electrodes in different stages. For example, depending on the application, one might use non-sacrificial anodes for bulk of the contamination removal and sacrificial anodes for minority of the contaminants or vice versa.

Although embodiments of the invention have focused on use of a plurality of electrocoagulation steps, in some embodiments more than one electrocoagulation step is not required. For example, in some embodiments electrocoagulation may be conducted with a cathode, a non-sacrificial anode, and a metal coagulant as described above. This permits the removal of organic contaminants, oil, and inorganics including but not limited to silica, hardness, boron, and phosphate.

The application of DC voltage during the enhanced electro coagulation process also significantly disinfects the water. Turbidity is typically removed to a level of less than 5 NTU. Embodiments of the invention can be run in one single stage or multiple stages to separate contaminants at different electrical conditions. The residence time and current can be varied to adjust removal to contaminants. The enhanced EC process is able to remove the bulk of major contaminants, and after an enhanced EC treatment stage the water can be taken for evaporative processes. The remaining contaminants can still cause damage, especially after feed water is concentrated to higher concentration. Our multi-contaminant co-precipitation process removes difficult to treat contaminants, which may otherwise need elaborate and expensive treatment. These contaminants cause scaling, which makes the treatment through reverse osmosis difficult or limits the recovery or prevent a zero liquid discharge process and potentially causes brine handling problems. While an enhanced EC process is efficient in removing bulk of the contaminants, removal of the remaining concentration of some of the contaminants, like hardness, to levels where they can not cause scaling requires additional steps.

Typically the enhanced EC process also sets the pH in the optimum range for further processing. The enhanced EC process also consumes bicarbonate and carbonate to precipitate contaminants, so there is a reduction of these components through this process. This reduces chemical consumption in subsequent processes and also reduces chances of precipitation of hardness.

The enhanced EC process becomes more efficient at higher temperature due to accelerated rate of reaction in terms of silica and hardness and reduction of other contaminants. This also delivers higher energy efficiency. In preferred embodiments of the invention the enhanced EC process is conducted between 50-90° C., 60-90° C., 70-90° C., 80-90° C., 85-90° C., and 85° C.

An additional feature of embodiments of the invention is that the pH shift can be controlled by magnitude of DC current applied, residence time in the enhanced EC system, any type of electrodes, and number of stages of EC. For example, if the pH has to be increased, the operator will have multiple options. Current can be increased by increasing the voltage, Residence time can be increased within the enhanced EC unit by reducing flow, or, alternatively, one or more additional stages of EC can be added. One can also achieve a positive shift in pH by changing electrode material in different stages based on the response of the electrode to the water contaminants. The pH shift combined with the reduction of all the contaminants makes it suitable for further processing for down stream evaporation or for use in a membrane process to achieve the purified water.

Although electrocoagulation is a known process, there has been no integration of that process with evaporative processes, membrane processes, and ion-exchange units for treatment of produced water to remove complex contaminants. Furthermore, there has been no use of multiple stage electro coagulation, which is not multi-pass process involving multiple passes under same electric conditions. Multi stage electro coagulation involves multiple stages under different current densities targeted towards removal of contaminants in a sequential manner The failure to integrate these fails to take advantage of EC's ability to treat water at higher temperatures very efficiently. Our combination is unexpectedly and extremely effective in treating multiple co-existing contaminants in waters like produced water. This results in high contaminant removal efficiency without consuming chemicals while simultaneously conditioning pH in the right range for further processing.

Our proposed integrated process gives excellent results in performance and operating costs, which are extremely low compared to the conventional processes. Conventional processes consume large amounts of chemicals like magnesium oxide, soda ash, lime and caustic soda. They do not remove all the contaminants as mentioned above. Significantly, they also result in large quantities of sludge that are not easy to handle.

An enhanced EC process combined with other downstream processes can remove some of the very difficult to treat contaminants including but not limited to silica, calcium, magnesium, boron, and phosphates, along with complex naturally occurring organics, polymerized organics, asphatines, humic acids and organometallic compounds, oil, and color. An enhanced EC process further consumes alkalinity caused by carbonates and bicarbonates and shifts the pH in the right range. This keeps the balance of organics dissolved in solution for downstream evaporative or membrane based processes.

The composition and concentration of residual contamination in the product of enhanced EC and its pH are in the right range, preferably 9.5-10, which can be treated through HRU for evaporative processes and HRU and UF/MF membranes for an RO process. This is quite an unexpected behavior considering how difficult it is to remove these contaminants through conventional processes. Moreover this process of treatment does not involve multiple unit processes and operations. To the contrary it is extremely simple and user-friendly to operate. This becomes efficient for a zero liquid discharge process and substantially solves all known problems with brine handling. Of course, this should not be read to exclude the use or inclusion of additional processes, only that they are not required. For example, embodiments of the invention may permit purification by electro-coagulation of water at temperatures of up to, for example, 85° C.

In embodiments of the invention the enhanced EC process is followed by HRU, then by treatment through evaporators. The objective of HRU is to remove each type of hardness to less than 1 ppm, preferably to less than 0.2 ppm by single or multistage hardness reduction stages. The hardness is analyzed by EDTA titration process.

In further embodiments a zeolite based strong acid cation resin in sodium form can be used to remove hardness. This can be efficiently regenerated by sodium chloride. In the alternative, weak acid cation resin in hydrogen or sodium form can be used for removal of hardness. In certain cases multiple stages of sodium zeolite softener or a combination of sodium zeolite softener and a weak acid cation resin unit could be beneficial, but this would involve storage of acid.

After the pretreatment through enhanced EC and HRU, the balance of salts present in the water are predominantly sodium-based, which do not present scaling or precipitation problems. The downstream concentrated brine or crystallized salt becomes an excellent source of salt for regeneration. The removal of organics, oil and other contaminants, which adversely impact the performance of HRU, are already removed upstream. That means that any possibility of fouling of resin in HRU is remote.

The treatment through enhanced EC and HRU removes major organic and inorganic contaminants, which cause scaling in evaporators, or consume excessive chemical or cause fouling and this level of pretreatment is adequate for evaporators. This is also adequate to go to zero liquid discharge stage through evaporators and crystallizers and also to resolve brine handling. When ZLD is not required, brine neutralization does not pose any problems because the upstream process has already removed gel-forming contaminants.

An evaporative process useful in embodiments of the invention may include, for example, a brine concentrator or a brine concentrator and crystallizer. The brine concentrator could be a falling film evaporator running with mechanical vapor compression process or any other evaporation process. The crystallizer could be based on a forced circulation evaporator process, which may be based on a vapor compressor or direct steam. This process as understood is preferred for evaporative processes but further processing and purification is useful for treatment through reverse osmosis.

Further treatment through UF/MF should prevent fouling in RO membranes and achieve turbidity and SDI in the range where mostly all the colloids, which can cause fouling on RO membranes, are removed. After water has passed through UF membranes, the turbidity is reduced to less than 1 NTU, and preferably around 0.1 NTU. At this time SDI is also reduced to less than 5, and preferably around 3. The ultrafiltration membranes can be polymeric membranes. For example, they may be like poly-sulphone, poly-ether-sulphone, or poly-vinylidene fluoride. Other suitable membranes may be inorganic membranes including but not limited to ceramic membranes. When the temperature of the produced water is high, typically from 40-90° C., but as high as 90-95° C., inorganic membranes, including but not limited to ceramic membranes may be preferred.

The polymeric membranes deliver lower flux from 30-50 LMH. Ceramic membranes are able to operate at higher fluxes; for example, they may be from 150-250 LMH at 25 deg C and up to 500 LMH-1000 LMH at higher temperature. These membranes can be operated in cross flow or dead end mode and utilize back washing at a predetermined frequency. For example, that frequency may be 20-40 minutes, preferably about 30 minutes.

The backwash can be recycled back to upstream of the EC unit or of a solid separation unit. In additional to removing the colloids these membranes also remove oil, which could be a major cause of fouling on RO membranes. At this stage oil concentration is reduced to less than 1-2 ppm. This level of oil does not create any problem to membranes due to pH conditioning after the enhanced EC process.

The UF/MF membrane may also reduce significant amount of organics. This may be shown, for example, by reduction of color concentration and TOC level in the water. Fortunately the pH conditioning resulting from the enhanced EC keeps the balance of organics, which are already low, in a solubilized condition.

The combined removal of silica, boron, hardness alkalinity, organics, color and oil makes the water suitable for treatment through RO. The level of fouling and scaling contaminants in the pretreated water is such that concentration through RO will not cause scaling even after water recovery of more than 90% is achieved. This is made possible by the described multi-contaminant co-precipitation enhanced EC process.

The integrated treatment and application of polishing, hardness removal, and ultrafiltration processes makes beneficial processing through reverse osmosis possible. The produced water achieves a high degree of treatment, without requiring addition of significant amount of chemicals. As a matter of fact the integrated process is relatively chemical free in normal operation. For example, in some embodiments only a limited amount of chemicals may be added. For example, typical embodiments may involve only addition of polyelectrolyte to hasten settling of solids. In other embodiments, the addition of alkali, acid, or salt may be permitted, though there are embodiments that exclude one, two, or all of those things. This is in significant contrast to conventional processes, which are extremely chemical intensive both on the upstream and down stream of evaporative processes.

The integrated process reported herein treats all or substantially all of the contaminants in the feed water, including silica, boron, hardness and color, organics and oil for evaporator and additionally provides turbidity, SDI and oil treatment and produces an ultra low level of hardness (less than 1 ppm and mostly around 0.2 ppm as measured by EDTA titration process while reducing organics and color within acceptable range for RO treatment as measured by turbidity or TOC. Turbidity may be, for example, less than 1 NTU.

The reverse osmosis process may be based, for example, on polyamide membranes. Other commercially available reverse osmosis solutions may be used. The process will generally meet all of the feed water design guidelines provided by the membrane manufacturer. Specialized hot water membranes may be used once the temperature of the RO feed water exceeds the recommended operational temperature of conventional RO membranes. The RO process is typically designed at a moderate flux of about 12-16 GFD and operates at 10-70 Bar pressure. These may be varied depending on the TDS and temperature of operation. Higher or lower fluxes may be used depending on site-specific requirements such as water conditions.

Another advantage of various integrated processes of embodiments of the invention is that the may shifts the pH of the treated water to make the treated water alkaline. Typically the pH of the treated water is in the range of 9-10, preferably about 9.5. This helps in keeping the concentrated contaminants, the remaining organics and oil, and any other remaining impurities in solution during concentration through an evaporator or RO unit.

This also provides the advantage that the pH of the water is also not excessively shifted to an extent that the brine may need neutralization after concentration. Usually this would require further acid consumption for the neutralization. So in various embodiments of this process both alkali and acid are saved. This may have significant advantage over a conventional process, where the pH has to be raised to 10-11 early in the process by addition of alkali. At this point in the process pH adjustment typically requires addition of large quantities of chemicals both because of the buffering action of contaminants and to keep the contaminants like silica soluble in evaporators. After that evaporation brine has to be neutralized with large quantities of acid. This may cause hardness scaling during evaporation.

Further dissolved silica may be removed by precipitation during neutralization, resulting in formation of a gel like slurry. This is difficult to dispose of because of formation of precipitated silica into a gel-like substance.

Another advantage of treatment according to embodiments of the invention is elimination of foaming during evaporation. This, in turn, reduces or eliminates the need for addition of continuous de-foaming chemicals during evaporation process. This eliminates a sometimes difficult-to-control element of conventional processes.

In one embodiment of the invention, a feed water can be processed through an enhanced EC process followed by HRU where TDS removal is not required. TDS might not be necessary, for example, where an operator is taking the purified water stream for use in a low pressure boiler.

Another embodiment offers integrated treatment through enhanced EC, UF and HRU, and also ensures trouble free operation and removes silica, hardness, organics, oil and color and also provides turbidity (<1) and SDI to make water fit for treatment through RO membrane at high recovery. This recovery may be, for example, around 90%. This would result in generation of high quality permeate. The HRU and UF/MF together and downstream of enhanced EC can be used in any sequence to make water treatable through RO.

One additional advantage of embodiments of this process is that it can treat feed water over a wide range of temperatures. Although in some embodiments the maximum temperature limit is 80-90 deg C, typically around 85 deg C, other temperatures are possible. This is normally considered unusual for a reverse osmosis based membrane process. The offers a unique process advantage through conservation of the heat available in the feed water and reduction of the osmotic pressure of the feed water. This also makes the process extremely energy efficient overall. The hot produced water, which is typically available at 80-85° C., need not be cooled for treatment and heated again for steam generation through boilers before injecting into deep wells for recovery of oil.

The brines generated by evaporators or reverse osmosis, followed by evaporative processes, are easily treated without generation of any gelatinous or tarry substance during subsequent pH adjustment, if required, for brine conditioning. Moreover the brine can be taken all the way to zero liquid discharge by evaporating all the liquid to solids. This creates a free flowing solid. This is very difficult to handle in a conventional process due to creation of a tarry mixture of highly concentrated organics, which is also very difficult to dispose of.

The reverse osmosis system can be a single stage system or double pass permeate system, where permeate of first stage RO is passed through a second stage RO to get better quality permeate. In this case the concentrate of second stage RO is sent back to feed of first stage to conserve water and achieve high recovery. The overall process, including RO, can be run at different temperatures, including in steam flood applications where the produced water comes out hot. As a matter of fact the performance of system in terms of removal efficiency of major contaminants like silica and hardness is better at higher temperature.

The integrated process of enhanced EC followed by HRU and UF or MF can also be used on high hardness and silica and or organics contaminated water. Typically these waters are limited in their recovery by silica, hardness or organics concentration. By integration of a crystallizer and evaporator, or a crystallizer, high brackish water can be treated to deliver high recovery and zero liquid discharge. This can also be applied as a retrofit to current RO plants to recover more water from their reject water and take them to zero liquid discharge by integrating it with a crystallizer or an evaporator and crystallizer.

Embodiments do not require consumption of significant chemicals for efficient operation. The only chemicals typically used are small quantities of polyelectrolyte for aiding coagulation and settling. Chemicals may also be used for cleaning, which is typically necessary infrequently. The treatment removes all or substantially all of the contaminants that results in scaling, precipitation, or fouling, or that increase or require chemical consumption or create difficulties in conditioning of brine or reject water after the recovery of distillate or permeate or adjustment of pH or neutralization.

Typical embodiments of the invention may include one or more of the following approaches or elements:

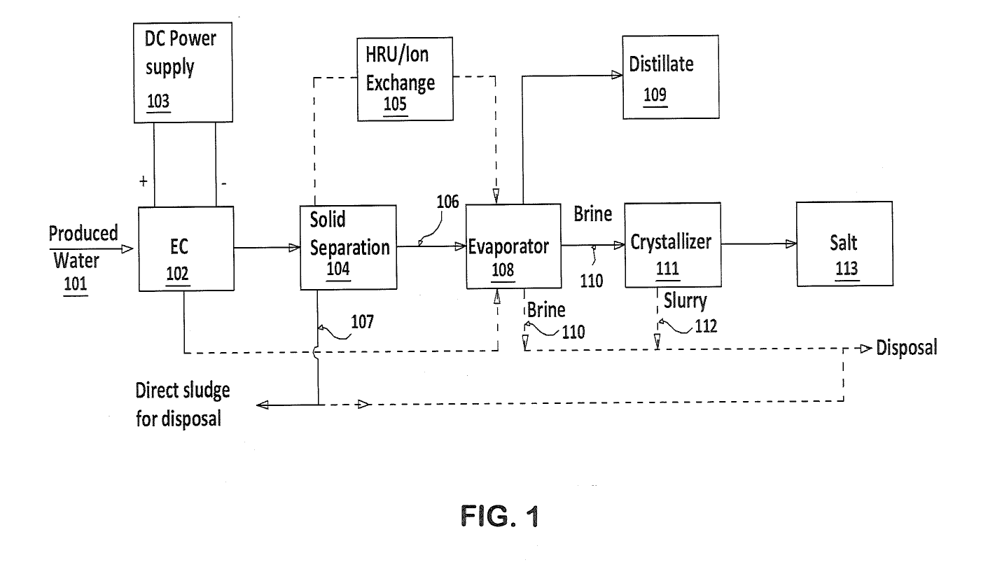

1. Treatment through electrocoagulation followed by a softener [HRU] followed by recovery of distillate through evaporators and an optional crystallizer to go to a zero liquid discharge stage.
2. Treatment through electrocoagulation followed by a HRU and a UF/MF and production of permeate water through an RO unit. The concentrate of the RO unit can be directly sent for disposal after pH adjustment (if required) The concentrate may also be further concentrated in a brine concentrator and/or crystallizer to go to a ZLD stage.
3. The RO unit may include two pass permeate to get higher quality of permeate. In this case the first pass permeate passes through a second pass RO, and the reject of second pass permeate is re-circulated back to upstream of first pass RO. In certain cases second pass permeate may be further passed through Ion exchange demineralizers or electro dialysis units to get ultra pure water.
4. The HRU and UF can be any order unless specifically stated otherwise. That is, UF can be on the downstream of HRU, or HRU can be on the down stream of UF. They can be interchanged to get almost similar results.
5. Treatment through electro coagulation followed by a HRU. The water is then taken for beneficial use where TDS and other quality parameters are not required by specifications for performance.
6. Treatment through electrocoagulation followed by a HRU and a UF/MF and production of permeate water through an RO unit. The concentrate of the RO unit can be directly sent for disposal after pH adjustment (if required). The concentrate may also be further concentrated in a brine concentrator and/or crystallizer to go to a ZLD stage. The water is further treated using membrane distillation and recovery of distillate from the RO reject.
7. Processes reported herein maybe carried out, for example, at elevated temperatures. A preferred temperature is about 85° C.
8. In approaches 1, 2 and 3 above the HRU unit can be optionally regenerated by brine or salt generated by RO, evaporators or crystallizers. This is because brine or salt generated in this process is relatively pure and does not contain large contaminants like hardness and silica.
9. Embodiments may include application of a controlled amount of DC electrical energy for the treatment of produced water from a DC power supply to an electrocoagulation (EC) unit. This leads to reaction of a sacrificial anode material with the contaminants to coagulate, hydrolyze and oxidize the impurities. The reacted impurities are then precipitated and separated through a solid separator, and the purified water is taken for further processing as described in FIGS. 1, 2 and 3. This process removes more than 90% of silica, hardness, TOC and color contributing organics. All this happens together without need for use of any chemicals like caustic soda, acids or magnesium oxide, etc. Further this can be employed over a wide range of temperature and performance gets better at higher temperature. This process can be performed in multiple electrical stages to optimize the process.

The anode material of the enhanced EC unit is consumed in the process and needs to be replaced at controlled intervals. Suitable anodes may include but are not limited to iron, and aluminum. The power required for the reaction is insignificant and very low voltage DC power. The process may be controlled by selection of anode material for the process, managing the resistance between electrodes and supply of electrical voltage to generate the right amount of current and controlling the residence time. All these parameters are adjusted based on quality of water, type of impurities and level of removal required. One of the advantages of typical embodiments is that they require minimum controls once the process is standardized, while still treating all the contaminants. This may require lower electrical energy for high TDS water due to higher conductivity and higher electrical energy for low TDS water.

10. Embodiments can be made further efficient to reduce energy consumption by creating multistage operations that are under the influence of different electrical potentials at each stage. Optionally each stage has a different electrode material and residence time. This also offers flexibility to adjust the resulting pH into a desired range for further processing. This may be done in-situ by adjusting the electrical conditions in the EC unit.
11. Embodiments as reported herein work well as pretreatment for integrated treatment of produced water and oil sands water especially for further processing treatment through evaporators to produce distillate and treatment through ion exchange and reverse osmosis after few more purification steps.
12. Embodiments can also be used for replacement of the lime softening or warm or hot lime soda process without use of all the required chemicals and generation of heavy sludge, while still delivering better water quality and presenting a smaller equipment footprint.
13. Treatment of produced water in the electrocoagulation process generates top and bottom layers of sludge. The sludge can be separated and filtered in a solid separation unit before the water is forwarded for evaporative processes in evaporators. The sludge generated by this process is highly coagulated with metallic coagulants, which makes it compact and easy to dewater than non-coagulated sludge. It normally passes the toxicity characteristic leaching procedure (TCLP) test for disposal. The separated sludge can be mixed with the conditioned brine generated in the subsequent processes for disposal based on the facilities and environmental regulations at site.
14. Alternatively only the top layer of sludge, which contains predominately the oil, organic and color contributing compounds, can be separated and the water with balance bottom inorganic layer can be taken for evaporative processes. In this case the solids will be disposed along with the brine. But this may not be preferable due to possibility of hardness scaling.
15. Embodiments also effectively pretreat contaminants for treatment through reverse osmosis after further pretreatment through hardness removal units and membrane units like microfiltration and ultrafiltration. The hardness removal unit and micro filtration or ultrafiltration can be in either sequence; that is, the hardness removal unit can be on the upstream of membrane unit or membrane unit can be on the upstream of hardness removal unit. Optional use of polishing hardness removal units can be made. These RO units can be operated at high recovery and RO rejects can be utilized to regenerate hardness removal units to keep the overall process low in chemical consumption. The regeneration waste along with rest of the brine water can be taken for disposal or taken for further evaporation or crystallization as desired.

We will now describe a preferred embodiment of the invention with reference to the figures. It will be understood that this embodiment is exemplary only, and should not be construed to limit the invention as defined in the claims. An overall flow scheme of one embodiment is shown in FIG. 1. This includes an electrocoagulation (EC) unit 102 in which tar sand produced water 101 is treated by applying controlled DC current through DC power supply 103, where the top sludge will be removed. The water can also be optionally treated through a de-aerator before the water is fed into EC unit 102. The product of electrocoagulation is transferred into a separation device 104 where the supernatant is decanted. The treated water through EC after separation of sludge can be treated through HRU. After hardness removal the water is taken for evaporation.

The decanted and purified water 106 is then taken into an evaporator 108 for distillate 109 production. The residual brine 110 can be directly disposed or sent to a crystallizer 111 for further concentration and distillate 109 production. The final brine 112 from the crystallizer 111 is sent for disposal into deep well or by trucking as applicable and salt 113 is sent for storage, disposal or beneficial use. It is possible to mix the electrocoagulation sludge 107 with this brine for disposal. The separated sludge 107 can also be sent to filter press or centrifuge for disposal as sludge or to be mixed in the brine concentrator (evaporator) brine 110 or crystallizer slurry 111 before disposal.

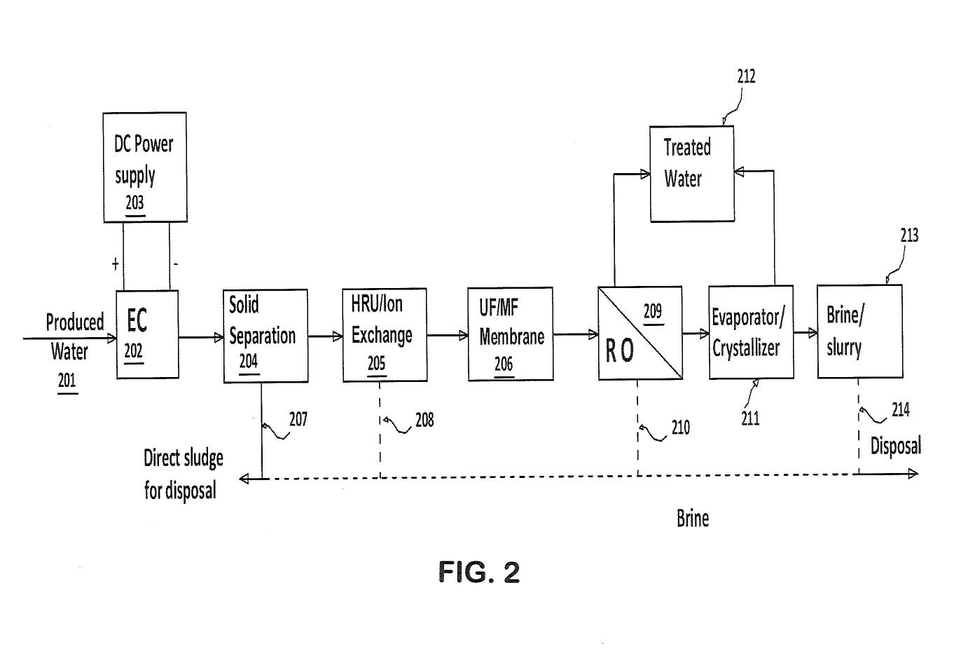

Another embodiment of our process is shown in FIG. 2. In that figure, produced water 201 is processed through an electro coagulation unit 202 where the controlled DC current is applied for the removal of impurities like silica, hardness, color, TOC, oil & suspended particles from the produced water and the treated water is then fed into solid separator 204 for sludge 207 separation. The treated water then further purified through hardness removal units (HRU) 205 and ultra or microfiltration units 206. The sequence of hardness removal and micro or ultrafiltration can be either way i.e. hardness removal step can come first or micro or ultrafiltration can come first. The purified water is then passed through a reverse osmosis system 209 and more than 90% treated water 212 is recovered. Recovery up to 95-98% is possible to achieve a brine concentration of 150000 ppm TDS. The reject 210 out of RO units can be sent to a brine concentrator and crystallizer 211 or directly into a crystallizer. The final brine or slurry 213 coming out of RO units 209 or thermal evaporation units 211 can be optionally used for regeneration of strong acid cation based hardness removal unit 205.

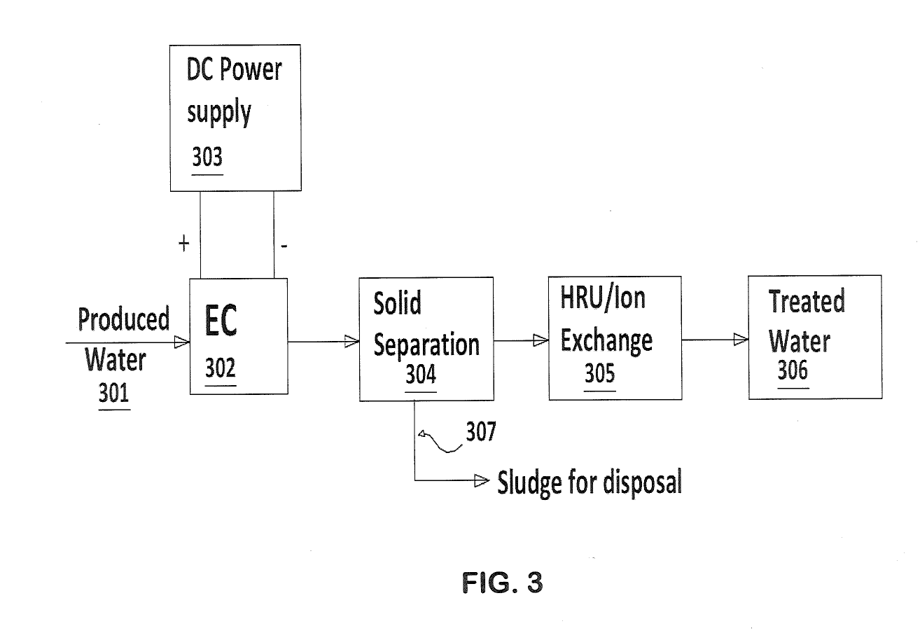

Another embodiment is shown in FIG. 3. In that figure the produced water 301 is treated in an EC unit 302 with the help of controlled DC current through DC power supply 303. The sludge 307 of EC unit is separated through solid separator 304 and sent for disposal as per local regulations norms. The decanted treated water is then passed through HRU unit 305 for the removal of residual hardness. The treated water 306 of HRU unit 305 can be used for beneficial use, if there is no TDS limit for treated water for recycling.

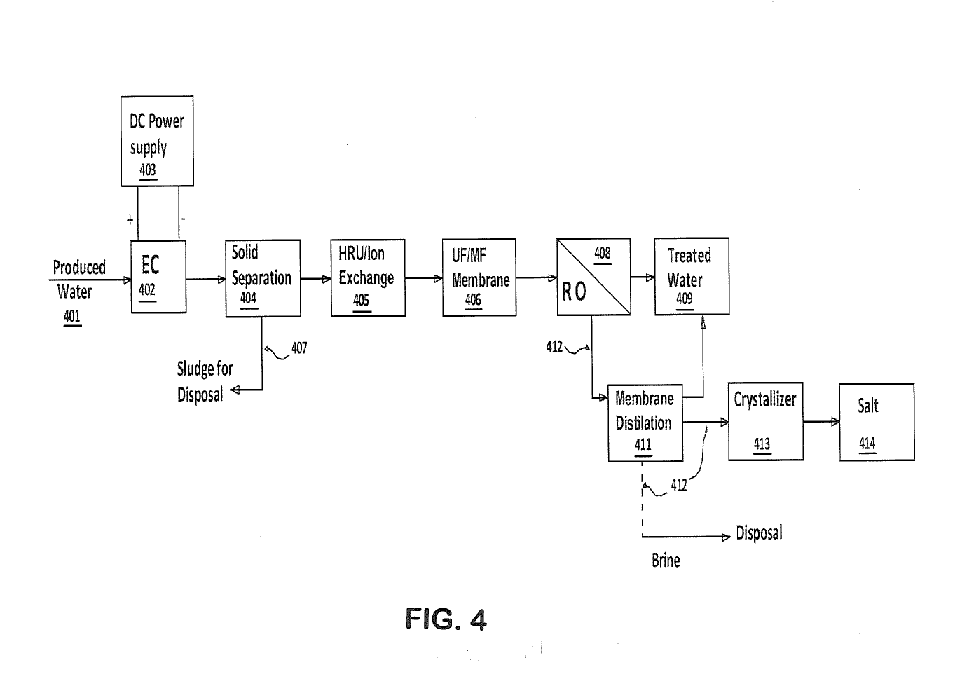

FIG. 4 shows a further embodiment of the invention in which the utilization of membrane distillation system 411 for the concentration of reject water 410 of RO unit 408 up to a level of 25% to 30% and recovered further purified water 409 and increased the overall recovery up to 98%. In this treatment scheme produced water 401 first treated in EC unit 402 by applying DC current through DC power supply 403. After solid separation 404, decanted water can be passed through HRU unit 405 and then UF/MF system before treated through RO unit 408. The concentrated brine 412 after membrane distillation system 411, can be either sent for disposal or further treated in crystallizer 413 where it convert into salt and recovered most liquid as distillate.

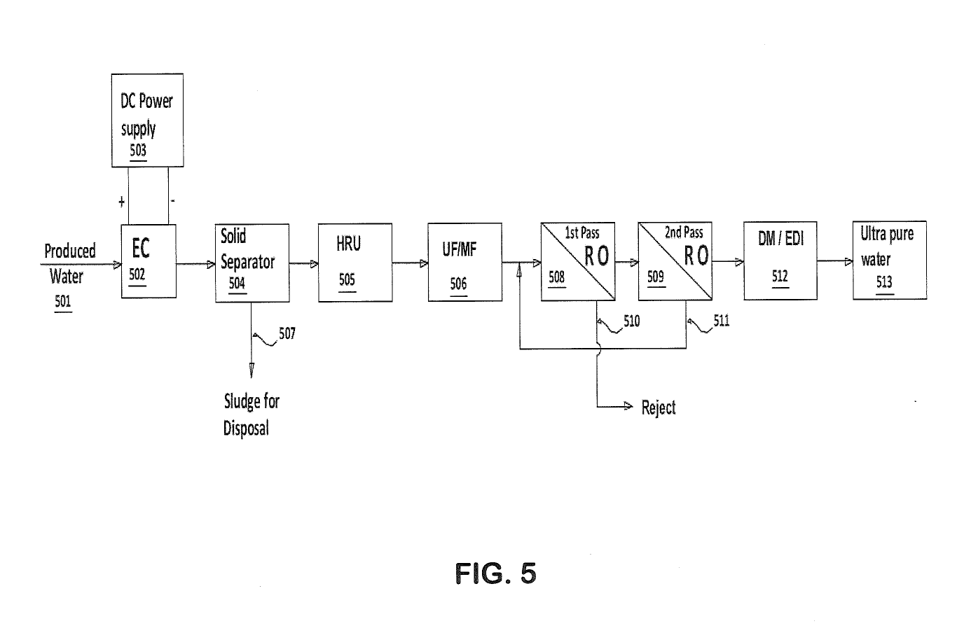

In some embodiments, the distillate, treated water, or permeate water from evaporators, HRU/ion exchange units, or RO units are fed to boilers after further treatment, if required, through demineralizers, an ion exchange unit or an electrodeionization process and the steam is released for the SAGD process. The return stream of oil and water is separated, and the water is sent for treatment through the EC units and the subsequent processes as described above. Another treatment scheme of the process is shown in FIG. 5. Based on this figure, ultra pure water can be produced by treating double pass RO permeate through demineralizers (DM) or electro deionization (EDI) 512. Produced water 501 after treated through EC 502, HRU 505 and UF/MF 506, fed into first pass RO system 508 and permeate of first pass RO is fed in second pass RO 509. The second pass RO reject water 511 is recycled back to feed of first pass RO 508 to enhance the recovery up to 90% or more. Reject water 510 of first pass RO 508 can be dispose along with EC sludge 507 as per disposal norms.

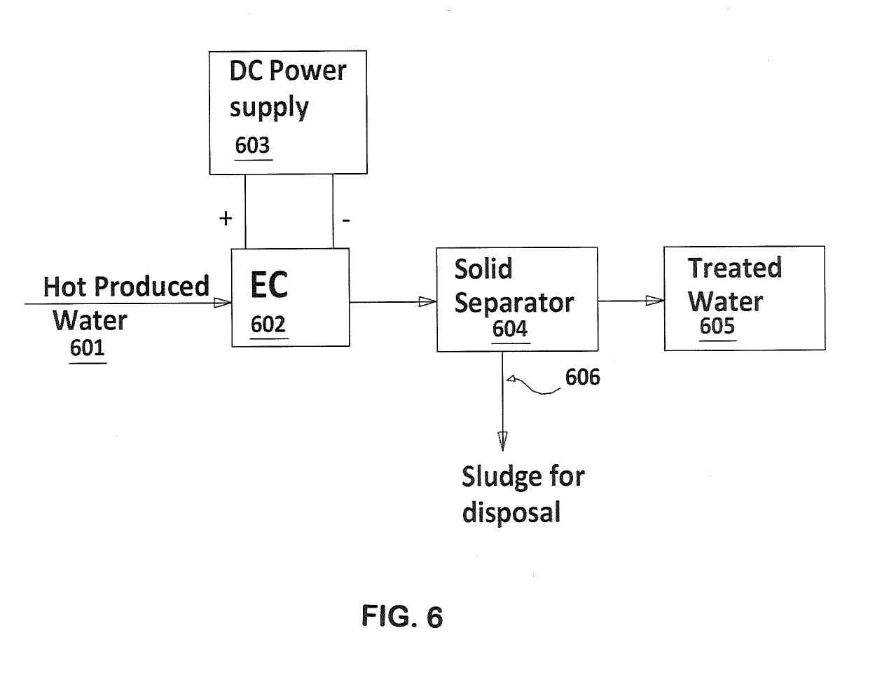

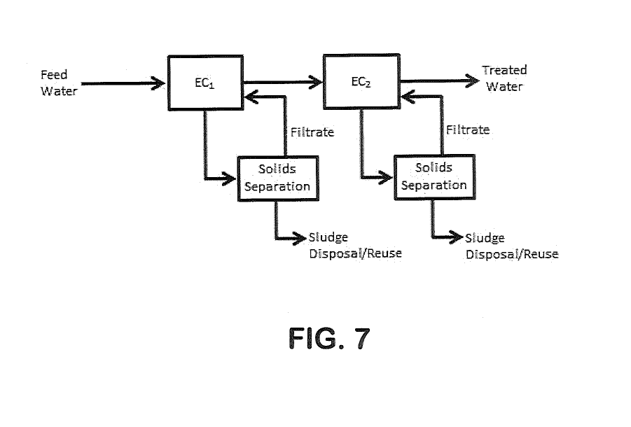

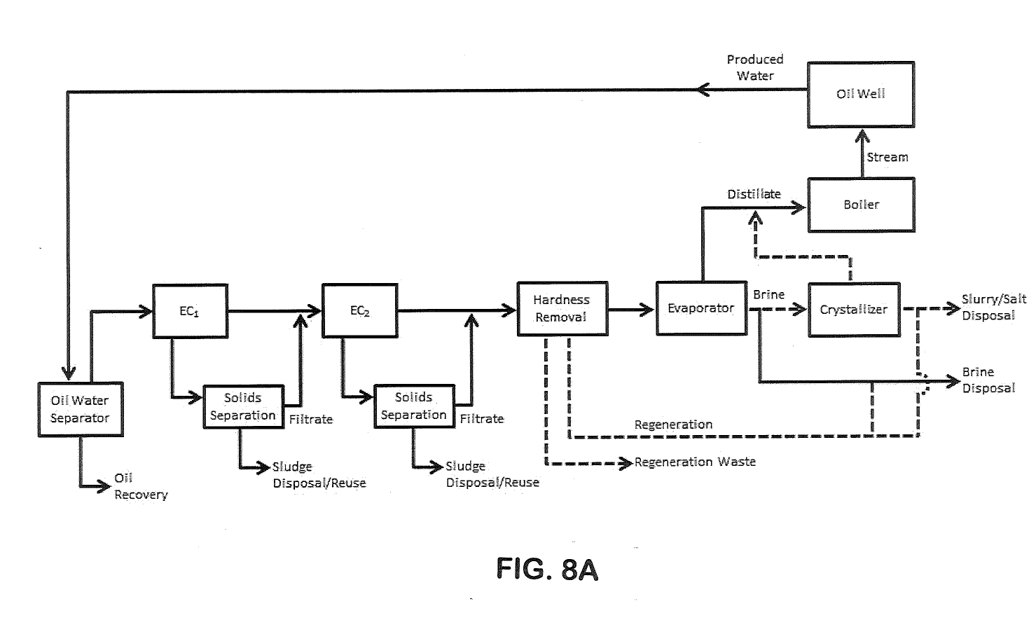

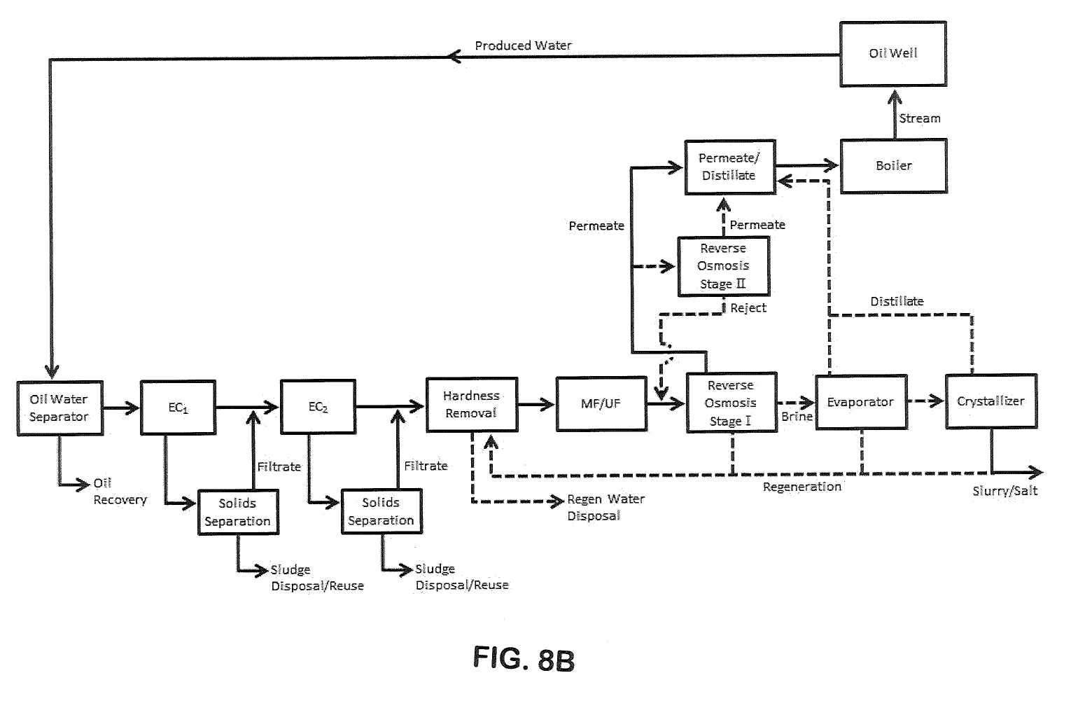

FIG. 6 shows an application EC application to replace lime softening for silica reduction, which can be in hot or warm conditions. Here the water is processed through EC unit 601 and power supply unit 603 and sent for solid removal units 604. The clarified water provides water with more than 90% removal of silica with significant removal of hardness and other contaminants.

Embodiments of the invention will now be further made clear through reference to operating examples.

### Example 1

In this trial tar sands produced water was treated through an enhanced electro coagulation (EC) process. A small lab scale EC unit was used, consisting of cylindrical shape acrylic housing and metal electrodes. Six numbers of mild steel carbon steel electrodes of size 110 mm×90 mm×2 mm used as anode and six numbers of stainless steel (SS 316) electrodes of size 110 mm×90 mm×1 mm were used as cathodes in the EC unit. The anodes and cathodes electrodes were assembled in alternating sequence, maintaining 6 mm gap between the electrodes. A DC power supply was used for applying the DC current to EC unit.

Different sets of treatment trials were conducted through EC process on produced water containing very high amounts of silica and organic color. DC current was varied from 1.5 amps to 3.5 amps, with 30 minutes residence time in trials. In EC process two types of sludge formation was observed, the light sludge contains organic impurities floats on water surface, which was removed by skimming process and the heavy sludge containing inorganic impurities was removed by the addition of Polyelectrolyte. AT-7594 (WEXTECH), 1 ppm, was used as polyelectrolyte for the fast settling of inorganic sludge. In the last experiment excessive foaming and some charring was observed with significant loss of water with sludge. This process was carried out in multiple stages, when 1.5 amp was applied for 15 minutes followed by 4.5 amp for 5 minutes. Sludge property was significantly better with minimum loss of water. The process did not have any foaming and remained under control.

EC process operating conditions and treated water quality of trials are tabulated in Table 1 & Table 2 respectively. The EC process removal efficiency is tabulated in Table 3.

TABLE 1
EC Unit operating conditions

| Trial conditions | Trial-1 | Trial-2 | Trial-3 |
|---|---|---|---|
| Raw Water Volume, mL | 2000 | 2000 | 2000 |
| Applied DC current, Amps | 1.5 | 2.5 | 3.5 |
| Applied DC voltage, Vdc | 1.5 | 2 | 3 |
| Residence Time, Minute | 30 | 30 | 30 |
| Polyelectrolyte Dose, ppm | 1 | 1 | 1 |

TABLE 2
Treated Water Quality

| Parameters | Unit | Raw water | Trial-1 | Trial-2 | Trial-3 |
|---|---|---|---|---|---|
| pH | | 7.82 | 9.68 | 9.79 | 10.06 |
| Conductivity | μS/cm | 3670 | 3580 | 3560 | 3570 |
| Color | PtCo | 3710 | 171 | 141 | 93 |
| Silica as SiO2 | ppm | 220 | 20 | 4.0 | 1.0 |
| TOC | ppm | 326 | 110 | 95 | 75 |
| Hardness as CaCO3 | ppm | 65 | 24 | 14 | 12 |
| Alkalinity as CaCO3 | ppm | 138 | 97 | 85 | 64 |
| Bicarbonates as HCO3 | ppm | 167.3 | 79.6 | 63.3 | 34.2 |
| Carbonates as CO3 | ppm | 0.51 | 17.6 | 18 | 18.2 |
| COD | ppm | 770 | 270 | 230 | 210 |

TABLE 3
EC Process Removal Efficiency

| Parameters | Trial-1 | Trial-2 | Trial-3 |
|---|---|---|---|
| Color Removal Efficiency | 95.4% | 96.2% | 97.5% |
| Silica Removal Efficiency | 90.9% | 98.2% | 99.5% |
| TOC Removal Efficiency | 66.3% | 70.9% | 77.0% |
| COD Removal Efficiency | 64.9% | 70.1% | 72.7% |
| Hardness Removal Efficiency | 63.1% | 78.5% | 81.5% |
| Alkalinity Removal Efficiency | 29.7% | 38.4% | 53.6% |

This shows that EC is an efficient process for the removal of impurities from oil sands produced water to the maximum extent and provides optimum conditions for further treatment of treated water through other processes. It is important to note the pH shift and bulk removal in the process. The residence time and other operating parameters can be changed to modify the pH.

### Example 2

In this experiment the tar sand produced water was treated as shown in FIG. 1 (Treatment scheme-1). The tar sand produced water was first treated by EC process through the EC unit used in Example 1. EC process operating conditions, treated water quality and impurities removal efficiency are summarized in Table-4 and 5.

TABLE 4
EC Unit operating conditions

| Parameters | Conditions |
|---|---|
| Raw Water Volume, mL | 4000 |
| Applied DC current, Amps | 2.5 |
| Applied DC voltage, Vdc | 2.0 |
| Residence Time, Minute. | 30 |
| DC Power consumption, kwh/m³ | 1.25 |
| Polyelectrolyte Dose, ppm | 1.0 |
| Sludge Volume, mL | 220 |

TABLE 5
EC Process Treated Water Quality & Removal efficiency

| | | | Treated | Removal |
|---|---|---|---|---|
| Parameters | Unit | Raw water | Water | Efficiency |
| pH | | 7.79 | 9.63 | |
| Conductivity | μS/cm | 3050 | 3060 | |
| Color | PtCo | 4650 | 137 | 97.1% |
| Silica as SiO2 | ppm | 116 | 2.0 | 98.3% |
| TOC | ppm | 292 | 104 | 64.4% |
| Hardness as CaCO3 | ppm | 20 | 10 | 50.0% |
| Alkalinity as CaCO3 | ppm | 152 | 88 | 42.1% |
| COD | ppm | 840 | 280 | 66.7% |
| Turbidity | NTU | 162 | 7.3 | 95.5% |

EC treated water after solid separation is passed through sodium zeolite based hardness removal unit (HRU) for the residual hardness removal and after HRU, outlet water residual hardness decreased to less than 1 ppm. Finally the treated water is evaporated in evaporator and recovered 97% of water (distillate). The brine of evaporator is further concentrated to crystallization stage The salt is light brownish in color, free of tar like materials, easy to grind and free flowing in nature.

As most of the impurities like organic color, silica, and hardness were removed in EC process, the treated water could be utilized for evaporation and distillation after passing through HRU unit as shown in FIG. 3.

Due to low concentration of impurities in above treated water, no foaming and scaling were observed in evaporator during evaporation. The evaporator and crystallizer brine water was analyzed and results are summarized in Tables 6 and 7. Finally the crystallizer brine neutralization to 9.5 pH did not produce any tarry slurry.

TABLE 6
Evaporator conditions

| Parameters | Conditions |
|---|---|
| EC Treated water volume, mL | 3,750 |
| pH adjusted | 10.5 |
| Caustic (10%) Solution consumption, mL | 4.0 |

TABLE 7
Brine water Quality

| | | Evaporator | Crystallizer |
|---|---|---|---|
| Parameters | Unit | Brine | Brine |
| Brine Volume | mL | 110 | 28 |
| pH | | 10.1 | 10.2 |
| Conductivity | μS/cm | 80600 | 307000 |
| Color | PtCo | 4100 | 18200 |
| Silica as SiO2 | ppm | 119 | 510 |
| TOC | ppm | 2278 | 9112 |

### Example-3

In this experiment a tar sand produced water was treated through a membrane based process after EC process (FIG. 2). The produced water was first treated through EC process where the most of the impurities were removed. The EC treated water contained less than 5 ppm of silica, less than 10 NTU turbidity and very low level of residual hardness. The EC treated water was then passed through zeolite based SAC based HRU unit and polymeric ultrafiltration membrane for the removal of residual hardness and turbidity. The outlet water of these units contains hardness less than 1 ppm and turbidity less than 0.1 NTU. The treated water at this stage met all requisites for further treatment through reverse osmosis. Finally, the water can be passed through RO membrane for permeate production and more than 90% recovery for further utilization based on the guidelines of membrane suppliers. The experiment results at various stages are summarized in Table-8 and 9.

TABLE 8
Treated Water Quality of example-3

| | | | EC | HRU | UF |
|---|---|---|---|---|---|
| | | Raw | Treated | Treated | Treated |
| Parameters | Unit | water | Water | Water | Water |
| pH | | 7.79 | 9.63 | 9.5 | 9.5 |
| Conductivity | μS/cm | 3050 | 3060 | 2970 | 2970 |
| Color | PtCo | 4650 | 137 | 91 | 85 |
| Silica as SiO2 | ppm | 116 | 2.0 | 2.0 | 2.0 |
| TOC | ppm | 292 | 104 | 93 | 90 |
| Hardness as CaCO3 | ppm | 20 | 10 | 0.2 | 0.2 |
| COD | ppm | 840 | 280 | 220 | 180 |
| Turbidity | NTU | 162 | 7.3 | 0.804 | 0.115 |

TABLE 9
Results of RO trial.

| | RO Feed | RO Permeate | Removal |
|---|---|---|---|
| parameters | water | water | % |
| pH | 9.5 | 7.5 | |
| Conductivity, μS/cm | 2970 | 220 | 92.6% |
| Color, PtCo unit | 85 | 20 | 76.5% |
| TOC, ppm | 90 | 18 | 80% |

### Example-4

In this experiment, oil sands produced water was treated at elevated temperature of 80-85° C. Produced water was first heated up to 80° C. and then passed through electrocoagulation (EC) unit where current was controlled to 2.0 Amps through DC power supply. The decanted treated water of EC unit was then passed through ceramic UF/MF membrane unit and finally the product water of UF/MF unit was treated through Zeolite based SAC based HRU unit for the removal of residual hardness. As the temperature of treated water of EC unit was found around 65-75° C., Ceramic membrane was used in UF/MF unit due to its temperature resistance properties. Results of treated water at various stages of experiment are summarized in Table-10. The quality of water at this stage met all the requisites for further treatment through reverse osmosis. The water was passed through a reverse osmosis membrane supplied by Hydranautics to generate permeate which were consistent with membrane projections given by the supplier.

TABLE 10
Treated Water Quality of Example-4

| | | | EC | UF/MF | HRU | |
|---|---|---|---|---|---|---|
| | | Raw | Treated | Treated | Treated | Removal |
| Parameters | Unit | water | Water | Water | Water | Efficiency |
| Temperature | ° C. | 80 | 65 | 50 | 40 | |
| pH | | 8.1 | 9.5 | 9.5 | 9.2 | |
| Conductivity | μS/cm | 5150 | 5080 | 5070 | 5010 | |
| Color | PtCo | 4620 | 121 | 105 | 108 | 97.6% |
| Silica as | ppm | 204 | 4.8 | 4.5 | 4.5 | 97.8% |
| SiO2 | | | | | | |
| TOC | ppm | 310 | 110 | 102 | 105 | 66.1% |
| Hardness as | ppm | 60 | 6 | 6 | 0.5 | 99.1% |
| CaCO3 | | | | | | |

We observed that at high temperature, around 80° C., treatment of tar sand produced water through EC unit followed by membrane based system & HRU system provides even better results. Hardness removal in EC unit reached up to 90%. Overall silica and hardness removal through this process is more than 95%. It's clearly demonstrated that the invented process for tar sand produced water treatment can also handle high temperature feed water and resulting in good quality product water for further use or processing.

### Example 5

In this experiment a two Stage Electro coagulation process was conducted with produced water. The first stage was run at 1.5 amp current and then subsequently the current was increase in the second stage to 4.5 amp. The first stage was given a residence time of 15 minutes and the second stage was run at 5 minutes. Silica rejection after completion of both stages is 95% & o&G rejection is 83%. Hardness and TOC rejection are 30% and 68% respectively. Foaming and sludge volume reduced significantly by 40%.

Table 11 shows a summary of the trial.

TABLE 11

| | Raw | Treated water | Treated water |
|---|---|---|---|
| Parameters | Water | Stage-1 | Stage-2 |
| pH | 8.64 | 8.68 | 9.50 |
| Conductivity, (μS/cm) | 9290 | 7380 | 7360 |
| Silica as SiO2 (ppm) | 146.7 | 22 | 6.5 |
| T. Hardness as CaCO3 (ppm) | 200 | 172 | 140 |
| T. Alkalinity as CaCO3 (ppm) | 476 | 444 | 412 |
| O& G (ppm) | 90.1 | 26 | 6.2 |
| Color, PtCo | 310 | 61 | <1 |
| TOC, ppm | 48.08 | 19.06 | 15.36 |
| Sludge volume, ml | — | 70 | 60 |

### Comparative Example 1

In this comparative experiment, produced water was treated by a conventional method. The pH of produced water was increased to 10 by sodium hydroxide and then passed through evaporator for evaporation. The pH of circulating water in evaporator is maintained around 10-10.5 by sodium hydroxide solution. Excessive NaOH solution was consumed for maintaining pH to prevent corrosion during evaporation. 10% (w/v) NaOH solution consumption was found around 5 Ltr per 1000 Ltr of produced water. Around 95% to 97% of distillate recovery was possible during evaporation. Huge foaming and heavy scaling on vessel were observed during evaporation.

The brine water of the evaporator was dark brown in color. We attempted to concentrate it further, but after recovering 1% more distillate, brine water became a dark colored, tar like slurry, and its color were observed 138000 PtCo unit. This slurry contained very little water and was very difficult to neutralize by acid. The scaling on vessel was found to be severe and very difficult to remove and clean. Analysis results of the comparative experiment are summarized in table-11.

TABLE 11
Results of comparative example

| | | Concentrated |
|---|---|---|
| parameters | Produced water | Brine water |
| pH | 8.05 | 10.50 |
| Conductivity, μS/cm | 5130 | 189000 |
| Color, PtCo unit | 4150 | 138000 |
| Silica as SiO2, ppm | 190 | 4500 |

1. A process for purification of a stream of water, comprising:
treating a stream of water by electrocoagulation;
treating the stream of water by a hardness removal unit;
treating the stream of water by at least one member of the group consisting of reverse osmosis, nanofiltration, a crystallizer, and an evaporator.

2. The process of claim 1, further comprising adjusting residence time of the step of treating a stream of water by electrocoagulation to adjust pH of the stream of water.

3. The process of claim 1, wherein the process removes boron, silica, calcium, magnesium, bicarbonate, color, organics, oil, strontium, and phosphate.

4. The process of claim 1, wherein the water is treated by reverse osmosis, and wherein the reverse osmosis treatment proceeds in more than one permeate stage followed by demineralization or electrodeionization.

5. The process of claim 1, further comprising treating the stream of water by at least one of nanofiltration, microfiltration and ultrafiltration before treating the stream by reverse osmosis.

6. The process of claim 1, further comprising treating the stream of water by an evaporator.

7. The process of claim 1, further comprising treating the stream of water by a crystallizer.

8. The process of claim 6, further comprising treating the stream of water by a crystallizer and collecting a brine slurry and salt from the crystallizer.

9. The process of claim 1, wherein the electrocoagulation process is conducted in a plurality of stages.

10. The process of claim 1, wherein the step of treating the water by at least one of microfiltration and ultrafiltration is conducted before the step of treating the water by a hardness removal unit.

11. The process of claim 1, wherein the stream of water is at a temperature between 80-90° during electrocoagulation.

12. The process of claim 1, further comprising regenerating the hardness removal unit with brine from at least one of the reverse osmosis unit, the crystallizer, and the evaporator.

13. The process of claim 1, wherein the electrocoagulation step produces a fractionated sludge comprising the majority of at least one of oil, organics, color compounds, hardness, silica, boron, and combinations thereof from the stream of water.

14. The process of claim 1, wherein the process does not require addition of chemicals other than polyelectrolytes during the electrocoagulation portion of the treatment.

15. The process of claim 1, wherein the stream of water is treated by reverse osmosis generating a reject, further comprising treating the reject by membrane distillation and generating a distillate and a concentrate, followed by treatment of the concentrate with a crystallizer.

16. The process of claim 1, wherein the stream of water is an input to or a product of a water selected from the group consisting of off-shore oil recovery water, off-shore gas recovery water, oil polymer flood water, water subjected to warm lime softening, coal to chemicals (“CTX”) process water, flue gas desulfurization water, coal seam gas (“CSG”) waters, coal bed methane waters, on-shore oil recovery water, on-shore gas recovery water, hydraulic fracturing water, shale gas extraction water, water including substantial biological content, power plant water, low-salinity oil recovery water, off-shore low-salinity produced water, and cooling tower blowdown water.

17. The process of claim 1, further comprising separating solids from the stream of water after each electrocoagulation step.

18. The process of claim 1, further comprising providing at least part of the stream of water from the electrocoagulation to an ion exchange unit for hardness removal and sending softened water from the ion exchange unit to the evaporator.

19. The process of claim 1, further comprising adjusting residence time of the step of treating a stream of water by electrocoagulation to adjust pH of the stream of water.

20. A process for purification of a stream of water, comprising:
treating a stream of water by electrocoagulation;
separating solids from the stream of water,
sending the solids for disposal;
treating the stream of water by hardness removal;
treating the water with at least one of an ultrafiltration membrane and a microfiltration membrane;
treating the stream of water by at least one of reverse osmosis and evaporation, and, crystallization, to produce purified water and a reject stream;
sending the reject stream from the reverse osmosis, evaporation and, crystallization, to a membrane distillation unit for additional processing;
collecting a distillate from the membrane distillation unit;
where the reject stream has been sent to a membrane distillation unit, sending a brine from the membrane distillation unit to disposal or sending the brine from the membrane distillation unit to a crystallizer; and
when the brine has been sent to a crystallizer, collecting salt from the crystallizer.

21. The process of claim 20, further comprising treating a reverse osmosis permeate by second stage reverse osmosis, and, further treating a permeate from the second stage reverse osmosis with a demineralizer or electrodeionization unit.

22. The process of claim 20, wherein the hardness removal is conducted by ion exchange.

23. The process of claim 20, further comprising adjusting residence time of the step of treating a stream of water by electrocoagulation to adjust pH of the stream of water.

24. The process of claim 20, wherein the electrocoagulation process is conducted in a plurality of stages.

25. The process of claim 20, wherein the stream of water is at a temperature between 80-90° during electrocoagulation.

26. The process of claim 20, wherein the electrocoagulation step produces a fractionated sludge comprising a majority of at least one of oil, organics, color compounds, hardness, silica, boron, and combinations thereof from the stream of water.

27. The process of claim 20, wherein the process does not require addition of chemicals other than polyelectrolytes during the electrocoagulation portion of the treatment.

28. A process for purification of a stream of water, comprising:
treating a stream of water by electrocoagulation;
separating solids from the stream of water,
sending the solids for disposal;
treating the stream of water by hardness removal.

29. A process for purification of a stream of water, comprising:
treating a stream of water by electrocoagulation at a first set of conditions; and
treating a stream of water by electrocoagulation at a second set of conditions, wherein the second set of conditions varies from the first set of conditions.

30. The process of claim 29, wherein the electrocoagulation is performed using a cathode and an anode material selected from the group consisting of a sacrificial anode or non sacrificial anode or a combination of a non-sacrificial anode a metallic coagulant.

31. The process of claim 30, wherein the non-sacrificial anode is made of a material selected from the group consisting of graphite, titanium, platinum, and tantalum.

32. The process of claim 31, wherein the metallic coagulant comprises at least one of iron salt and aluminum salt.

33. The process of claim 29, further comprising separating solids from the stream of water between treating the stream by electrocoagulation at a first set of conditions and treating the stream by electrocoagulation at a second set of conditions.

34. The process of claim 29, wherein the stream of water is an input to or a product of a water selected from the group consisting of off-shore oil recovery water, off-shore gas recovery water, oil polymer flood water, water subjected to warm lime softening, coal to chemicals (“CTX”) process water, flue gas desulfurization water, coal seam gas (“CSG”) waters, coal bed methane waters, on-shore oil recovery water, on-shore gas recovery water, hydraulic fracturing water, shale gas extraction water, power plant water, low-salinity oil recovery water, water including substantial biological content, off-shore low-salinity produced water, and cooling tower blowdown water.

35. The process of claim 29, wherein said second set of conditions varies from said first set of conditions in at least one aspect selected from the group consisting of electrode spacing, pH, residence time, electrode material, current density, and water temperature.

36. The process of claim 29, further comprising treating said stream of water by electrocoagulation at a third set of conditions, wherein the third set of conditions varies from the first set of conditions and the second set of conditions.

37. The process of claim 29, wherein each of the first set of conditions and the second set of conditions selectively removes a majority of at least one impurity selected from the group consisting of organics, color, boron, silica, calcium, magnesium, bicarbonate, oil, strontium, and phosphate, and wherein the at least one impurity removed by the first set of conditions and the at least one impurity removed by the second set of conditions are different.

38. The process of claim 29, further comprising treating the produced water with at least one member of the group consisting of evaporation, hardness removal, membrane filtration, crystallization, and reverse osmosis.

39. A process for treating water for heavy oil production, comprising:
(a) separating an oil and water mixture obtained from a first injection well into separate mixtures of oil and produced water;
(b) sending said produced water to a header of an electrocoagulation system as electrocoagulation feedwater;
(c) treating the produced water by electrocoagulation at a first set of conditions;
(d) treating the produced water by electrocoagulation at a second set of conditions, wherein the second set of conditions varies from the first set of conditions;
(e) generating steam with the produced water; and
(f) sending said steam to a second injection well, wherein said second injection well may be the same or different as the first injection well.

40. The process of claim 39, further comprising treating the produced water with a hardness removal unit.

41. The process of claim 40, wherein the step of generating steam with the produced water also generates boiler blowdown, further comprising treating the boiler blowdown with an evaporator and a crystallizer.

42. A process for treating water for heavy oil production, comprising:
(a) separating an oil and water mixture obtained from a first injection well into separate mixtures of oil and produced water;
(b) sending said produced water to a header of an electrocoagulation system as electrocoagulation feedwater;
(c) treating the produced water by electrocoagulation at a first set of conditions;
(d) treating the produced water by electrocoagulation at a second set of conditions, wherein the second set of conditions varies from the first set of conditions;
(e) removing solids from the produced water after the steps of treating the produced water by electrocoagulation;
(f) removing hardness from the produced water;
(g) treating the produced water by at least one process selected from the group consisting of reverse osmosis, crystallization, evaporation, ultrafiltration, nanofiltration, and microfiltration;
(h) generating steam with the produced water; and
(i) sending said steam to a second injection well, wherein said injection well may be the same or different as the first injection well.

43. The process of claim 42, wherein the produced water is treated by at least one of evaporation and crystallization.

44. The process of claim 42, wherein the produced water is treated by reverse osmosis.

45. The process of claim 42, wherein the produced water is treated by a membrane filtration process.

46. A process for purification of a stream of water containing organic and inorganic contaminants, comprising:
treating a stream of water by electrocoagulation, wherein electrocoagulation is conducted with a cathode, a non-sacrificial anode, and a metallic coagulant.

47. The process of claim 46, wherein the inorganic contaminants are selected from the group consisting of silica, hardness, boron, and phosphate.
